(19) United States
(12) Patent Application Publication
(10) Pub. No.: US 2012/0081521 A1
(43) Pub. Date: Apr. 5, 2012

(54) Apparatus and Method for Displaying Images

(75) Inventors: Hannu Vilpponen, Jarvenpaa (FI); Aki Happonen, Kiiminki (FI); Timo Yli-Pietilä, Tampere (FI)

(73) Assignee: Nokia Corporation

(21) Appl. No.: 12/894,215

(22) Filed: Sep. 30, 2010

(51) Int. Cl. H04N 13/02

(52) U.S. Cl. 348/51; 348/E13.075

(57) ABSTRACT

An apparatus and a method for displaying images are provided. In the method, first and second set of image pre-compensation parameters are read from a memory. An image is loaded, the image including at least one of sub-image pair, each pair including a sub-image intended to the left eye and a sub-image intended to the right eye. The first set of parameters is applied to the at least one sub-image of each pair intended to the left eye and the second set of parameters is applied to the at least one sub-image of each pair intended for right eye. The image is displayed on a stereoscopic display.

### FIELD

The invention relates to an apparatus and a method for displaying images.

### BACKGROUND

In many electronic devices, high resolution displays are used and the importance of the displays in the operation of the devices has been growing. The devices are equipped with larger displays than before and the graphical properties of the devices have improved drastically. For example, stereoscopic televisions have been introduced and stereoscopic displays for mobile devices have been proposed as well. Stereoscopic displays may offer users of the devices an enhanced user experience.

### BRIEF DESCRIPTION

According to an aspect of the present invention, there is provided an apparatus comprising: at least one processor; and at least one memory including computer program code; at least one memory and the computer program code configured to, with the at least one processor, cause the apparatus at least to read first and second set of image pre-compensation parameters from a memory; load an image, the image comprising at least one of sub-image pair, each pair comprising a sub-image intended to the left eye and a sub-image intended to the right eye; apply the first set of parameters to the at least one sub-image of each pair intended to the left eye and the second set of parameters to the at least one sub-image of each pair intended for right eye, and cause the displaying of the image on a stereoscopic display.

According to another aspect of the present invention, there is provided a method comprising: reading first and second set of image pre-compensation parameters from a memory; loading an image, the image comprising at least one of sub-image pair, each pair comprising a sub-image intended to the left eye and a sub-image intended to the right eye; applying the first set of parameters to the at least one sub-image of each pair intended to the left eye and the second set of parameters to the at least one sub-image of each pair intended for right eye, and causing the displaying of the image on a stereoscopic display.

According to yet another aspect of the present invention, there is provided a computer program embodied on a distribution medium, comprising program instructions which, when loaded into an electronic apparatus, control the apparatus to: read first and second set of image pre-compensation parameters from a memory; load an image, the image comprising at least one of sub-image pair, each pair comprising a sub-image intended to the left eye and a sub-image intended to the right eye; apply the first set of parameters to the at least one sub-image of each pair intended to the left eye and the second set of parameters to the at least one sub-image of each pair intended for right eye, and cause the displaying of the image on a stereoscopic display.

### LIST OF DRAWINGS

Embodiments of the present invention are described below, by way of example only, with reference to the accompanying drawings, in which

FIG. 1 illustrates an example of an electronic device in accordance with an embodiment;

FIGS. 2 and 3 are flowcharts illustrating embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

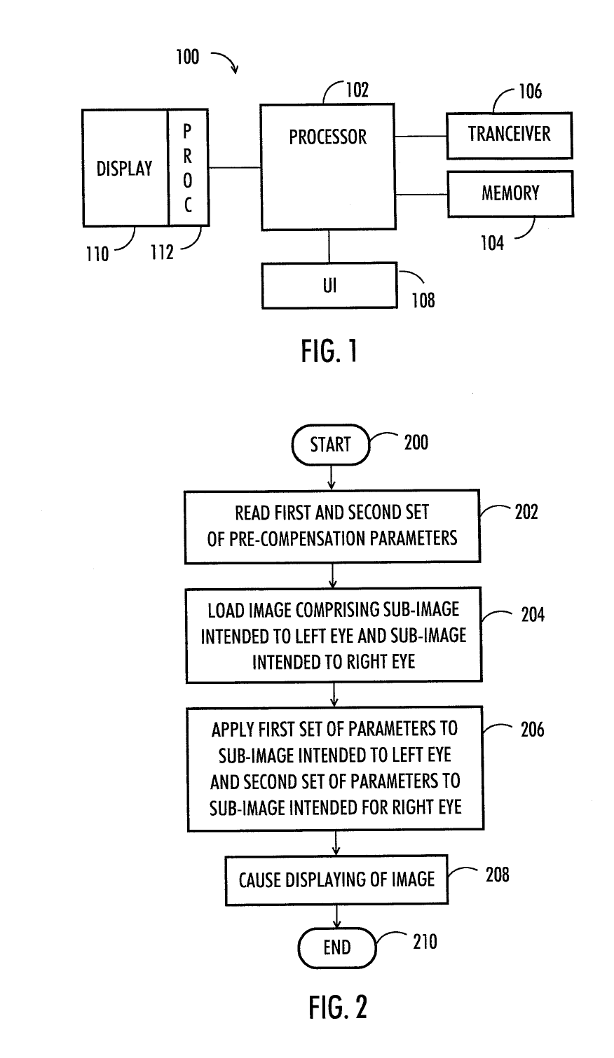

FIG. 1 illustrates an example of a block diagram of the structure of an electronic device 100 according to an embodiment. Although one embodiment of the electronic device 100 is illustrated and will be hereinafter described for purposes of example, other types of electronic devices, such as, but not limited to, portable digital assistants (PDAs), pagers, mobile computers, desktop computers, laptop computers, Internet pads, electronic book viewers, wearable devices, media players, and other types of electronic systems, may employ the present embodiments. Furthermore, the apparatus of an example embodiment need not be the entire electronic device, but may be a component or group of components of the electronic device in other example embodiments.

The electronic device of FIG. 1 comprises a processor 102 configured to execute instructions and to carry out operations associated with the electronic device 100. The processor 102 may comprise means, such as a digital signal processor device, one or more microprocessor device, and circuitry, for performing various functions described later. The processor 102 may control the reception and processing of input and output data between components of the electronic device 100 by using instructions retrieved from memory. The processor 102 can be implemented on a single-chip, multiple chips or multiple electrical components. Some examples of architectures which can be used for the processor 102 include dedicated or embedded processors, and ASICs (application-specific integrated circuit).

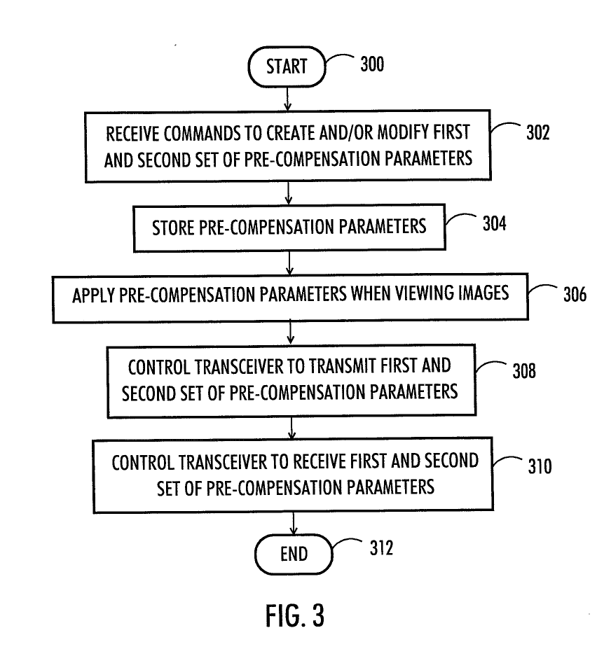

The processor 102 may comprise functionality to operate one or more computer programs. Computer program code may be stored in a memory 104. The at least one memory and the computer program code may be configured to, with the at least one processor, cause the apparatus to perform at least one embodiment including, for example, one or more of the functions described below in conjunction with FIGS. 2 and 3. Typically the processor 102 operates together with an operating system to execute computer code and produce and use data.

By way of example, the memory 104 may include non-volatile portion, such as EEPROM, flash memory or the like, and a volatile portion, such as a random access memory (RAM) including a cache area for temporary storage of data. The information could also reside on a removable storage medium and loaded or installed onto the electronic device 100 when needed. The memory 104 may comprise one or more memory circuitries and it may be partially integrated with the processor 102.

The electronic device 100 may comprise one or more transceivers 106 comprising a transmitter and a receiver. An antenna (or multiple antennae) may be connected to the transceiver. The electronic device 100 may operate with one or more air interface standards and communication protocols. By way of illustration, the electronic device 100 may operate in accordance with any of a number of first, second, third and/or fourth-generation communication protocols of cellular systems or the like. For example, the electronic device 100 may operate in accordance with wire line protocols, such as Ethernet and digital subscriber line (DSL), with second-generation (2G) wireless communication protocols, such as IS-136 (time division multiple access (TDMA)), Global System for Mobile communications (GSM), and IS-95 (code division multiple access (CDMA)), with third-generation (3G) wireless communication protocols, such as 3G protocols by the Third Generation Partnership Project (3GPP), CDMA2000, wideband CDMA (WCDMA) and time division-synchronous CDMA (TD-SCDMA), with fourth-generation (4G) wireless communication protocols, such as the Long Term Evolution (LTE) Advanced protocols, wireless local area networking protocols, such as 802.11, short-range wireless protocols, such as Bluetooth, and/or the like. The processor 102 may control the transceiver 106 to connect to another (source or target) communications device and communicate with the other communications device by using a data transfer service provided by the transceiver 106. In an embodiment, the transceiver is configured to communicate with another communication device using a wired connection, such as an Universal Serial Bus (USB).

The device may comprise user interface 108. The user interface may comprise an output device, such as a speaker, one or more input devices, such as a microphone, a keypad or one or more buttons or actuators. In addition, the device comprises a display 110 for displaying information. The display configured to display information in two or more dimensions. In an embodiment, the display is a stereophonic display configured to display three dimensional images.

The display 110 could be of any type appropriate for the electronic device 100 in question, some examples include plasma display panels (PDP), liquid crystal display (LCD), light-emitting diode (LED), organic light-emitting diode displays (OLED), projectors, holographic displays and the like.

The electronic device 100 may comprise also further units and elements not illustrated in FIG. 1, such as further interface devices, a battery, media capturing elements, video and/or audio module, and a user identity module.

There are various ways of realizing a stereoscopic display. For a mobile or portable device, so called autostereoscopic displays have been proposed. Autostereoscopic displays do not require the user to wear any glasses or spectacles. Three-dimensional effects are realized using optical elements in the display. Examples of optical elements are lenticular sheet and parallax barrier.

A three dimensional image comprises a sub-image intended to the left eye and a sub-image intended to the right eye. A lenticular sheet is an optical filter or a lens which refracts the light passing the sheet. The sheet may direct light rays into desired direction. A parallax barrier blocks the light in certain directions. Both methods enable the direction of different images to left and right eyes of the viewer. In an embodiment, the display 110 comprises means 112 for creating a stereoscopic image. The means may be realized with a lenticular sheet or a parallax barrier or any other suitable way well known in the art.

Both above described methods enable the display to show a stereoscopic image to a user. In addition, both methods support the display of more than two stereoscopic views. Thus, a stereoscopic display supporting multiple views may be viewed from multiple angles, each angle offering a slightly different stereoscopic view.

Besides the above mentioned methods, there are several other methods to implement stereoscopic displays. These methods include the use of polarization or time division. Both of these methods require the user to wear glasses. The images intended to the left and right eye can be sent simultaneously using different polarization and by wearing glasses with polarized glasses it is possible for the left eye to see only the images intended to the left eye, and the right eye to see only the images intended to the right eye.

The images may also be sent using time division in such a manner that the images intended to the left and right eye are displayed sequentially in turn. By wearing glasses having shutters which open and close the left and right eye lenses in synchronization with the display the left eye sees only the images intended to the left eye, and the right eye sees only the images intended to the right eye.

A stereoscopic image may be obtained using anaglyph images. In anaglyph images, complementary color filters are employed for each eye. For example, red and cyan or amber and blue filters may be used. By using glasses with respective filters a three-dimensional image is perceived.

The properties of displays may be adapted with the use of fluids or by mechanical bending.

In an embodiment, a stereoscopic image may be obtained using a multilayer display. A multilayer display comprises two or more displays stacked on top of each other and separated physically by depth. The front layer display is transparent and the back displays are viewable at the same time as the front display. Items on a front layer display seem to be closer than items on a back layer. Thus, a 3D effect is achieved without glasses.

In an embodiment, a display may comprise a prism-pattern on top of the display. The operation of the display is similar to displays utilizing a lenticular sheet or a parallax barrier. The prism reflects light at two different angles, which are received by a user's left and right eyes, creating a sense of depth without the use of glasses.

Further methods for obtaining stereoscopic images include the use of holograms, semitransparent mirrors or other optical solutions. The actual method with which a stereoscopic image is created is not relevant regarding embodiments of the invention.

In an embodiment of the invention, image pre-compensation is utilized in an apparatus for correcting vision impairments of the user of the apparatus. As the displayed images are pre-compensated the user is able to see the displayed image without any other vision correcting apparatus such as spectacles.

The pre-compensation parameters distort the displayed image in such a manner that the vision impairments of the user may be corrected and the user experiences the displayed image as a sharp image without distortions.

In an embodiment, two sets of image pre-compensation parameters are utilized, one for the left eye and one for the right eye. Utilizing a stereoscopic display it is possible to provide a pre-compensated image to both eyes independently.

One approach in the design of pre-compensation parameters is to consider the eyes as an optical system with point spread functions (PSF) E_{L} (x,y) and E_{R}(x,y) for the left and right eye.

The image R formed in the retina of the eye may thus be described as convolution equations

R_{L}(x,y)=I_{L}(x,y)*E_{L}(x,y) for the left eye and

R_{R}(x,y)=I_{R}(x,y)*E_{R}(x,y) for the right eye, where

I_{L} is the image seen by the left eye, I_{R} is the image seen by the right eye and * denotes convolution. The image may be shown on the display of an electronic device 100.

The point spread functions of the left and right eyes E_{L}(x,y) and E_{R}(x,y) comprise the information of the visual impairments of the eyes. Thus, if the image shown on the display of an electronic device 100 were processed before displaying by applying the inverse point spread function of each eye E_{L}⁻¹ (x,y) and E_{R}⁻¹(x,y) the image would be distorted on the display but the image formed in the retina of each eye would be sharp. The pre-compensated, distorted image shown on the display of the electronic device would be

I_{L}(x,y)*E_{L}⁻¹(x,y) for the left eye and

I_{R}(x,y)*E_{R}⁻¹(x,y) for the right eye.

Thus, the pre-compensated equations for image R formed in the retina of the eye would be as follows:

R_{L}(x,y)={I_{L}(x,y)*E_{L}⁻¹(x,y)}*E_{L}(x,y) for the left eye and

R_{R}(x,y)={I_{R}(x,y)*E_{R}⁻¹(x,y)}*E_{R}(x,y) for the right eye.

Thus, in an embodiment, the pre-compensation parameters are based on the inverse point spread function of each eye of the user. In general, the pre-compensation parameters are designed to traverse the visual impairments of the eyes. The convolution approach described above is merely an example of possible methods.

FIG. 2 is a flowchart illustrating an example of an embodiment. The example begins at step 200.

In step 202, first and second set of image pre-compensation parameters are read from a memory. The controller 102 may be configured to read the parameters from the memory 104, for example.

In step 204, an image is loaded. The image may be read from a memory or the image may be received by the transceiver 106. In an embodiment, when the display of the apparatus supports such a feature, the image may comprise multiple views. In such a case, the image comprises at least one of sub-image pair, each pair comprising a sub-image intended to the left eye and a sub-image intended to the right eye. Each sub-image pair supports thus one stereoscopic view and the number of pairs equals to the number of supported views. In an embodiment, one view is supported in which case the image comprises one sub-image intended to the left eye and one sub-image intended to the right eye.

The viewed images may be still images, videos or any graphical or textual representations as one skilled in the art is aware.

In step 206, the controller 102 is configured to apply the pre-compensation parameters to the image. In an embodiment where multiple views are supported, the first set of parameters is applied to the at least one sub-image of each pair intended to the left eye and the second set of parameters is applied to the at least one sub-image of each pair intended for right eye. In case of a single view, the first set of parameters is applied to the sub-image intended to the left eye and the second set of parameters is applied to the sub-image intended for right eye.

In step 208, the controller 102 is configured to cause the displaying of the image on a stereoscopic display 110.

The example ends at step 210.

FIG. 3 is a flowchart illustrating an example of an embodiment. The example begins at step 300.

In step 302, the apparatus 100 receives commands to create and/or modify the first and second set of image pre-compensation parameters. A user may visit an optician or an eye specialist and receive a prescription for spectacles for vision correction. The prescription comprises given vision correction parameters. The user may input the parameters to the apparatus using the user interface of the apparatus, for example a keypad or keyboard.

In an embodiment, the user may create the parameters from scratch without any prescription and find the best parameter combination by trial and error.

In step 304, the apparatus is configured to store the parameters into a memory.

In step 306, the parameters are applied when viewing images as described in connection with FIG. 2.

In step 308, the apparatus is configured to control the transceiver 106 to transmit the first and second set of image pre-compensation parameters. The user may transmit the pre-compensation parameters to a different apparatus or to an Internet service configured to store information.

In step 310, the apparatus is configured to control the transceiver 106 to receive the first and second set of image pre-compensation parameters. The parameters may be received from another apparatus or from Internet. The received parameters may be stored in a memory of the apparatus and the user may modify them if needed.

The example ends at step 312.

Embodiments of the invention offer several advantages. As the image pre-compensation parameters are user-specific and fit to his/her vision, the viewed images are sharp only to the specific user. This increases privacy and security. As the display is clear and sharp only to the user and unclear to others, the proposed solution enables personalization of devices in a higher degree than before. In addition, the user need not wear any spectacles or other vision correcting devices while viewing images. The proposed system for stereoscopic viewing suits for viewing still images, videos and electronic books, for example.

The same apparatus may be used by users with different vision correcting needs. The apparatus may be configured to store in a memory several sets of pre-compensation parameters, for more than one user. The correct parameters may easily be loaded from the memory.

In an embodiment, the set of parameters are automatically applied when loaded into the apparatus. Thus, the apparatus is ready to use immediately after loading the parameters. In another embodiment, a specific command given using the user interface of the apparatus is required for the apparatus to apply the parameters.

The electronic device 100 may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, execute the method described above in connection with FIGS. 2 and 3.

The computer program may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital computer or it may be distributed amongst a number of computers.

The steps described above in FIGS. 2 and 3 are in no absolute chronological order, and some of the steps may be performed simultaneously or in an order differing from the given one. Other functions can also be executed between the steps or within the steps. Some of the steps or part of the steps can also be left out or replaced by a corresponding step or part of the step.

An embodiment provides an apparatus comprising: means for reading first and second set of image pre-compensation parameters from a memory; means for loading an image, the image comprising at least one of sub-image pair, each pair comprising a sub-image intended to the left eye and a sub-image intended to the right eye; means for applying the first set of parameters to the at least one sub-image of each pair intended to the left eye and the second set of parameters to the at least one sub-image of each pair intended for right eye, and means for causing the displaying of the image on a stereoscopic display.

It will be obvious to a person skilled in the art that, as technology advances, the inventive concept can be implemented in various ways. The invention and its embodiments are not limited to the examples described above but may vary within the scope of the claims.

1. An apparatus comprising:
at least one processor;
and at least one memory including computer program code;
at least one memory and the computer program code configured to, with the at least one processor, cause the apparatus at least to
read first and second set of image pre-compensation parameters from a memory;
load an image, the image comprising at least one of sub-image pair, each pair comprising a sub-image intended to the left eye and a sub-image intended to the right eye;
apply the first set of parameters to the at least one sub-image of each pair intended to the left eye and the second set of parameters to the at least one sub-image of each pair intended for right eye, and
cause the displaying of the image on a stereoscopic display.

2. The apparatus of claim 1, further comprising user interface operatively connected to the at least one processor and configured to receive commands to create and/or modify the first and second set of image pre-compensation parameters.

3. The apparatus of claim 1, wherein the apparatus is configured to control a transceiver to receive the first and second set of image pre-compensation parameters.

4. The apparatus of claim 1, wherein the apparatus is configured to control a transceiver to transmit the first and second set of image pre-compensation parameters.

5. The apparatus of claim 1, wherein in each pair, the sub-image intended to the left eye and the sub-image intended to the right eye are identical.

6. The apparatus of claim 1, wherein the apparatus is configured to load the image from a memory.

7. The apparatus of claim 1, wherein the apparatus is configured to control a transceiver to receive the image.

8. A method comprising:
reading first and second set of image pre-compensation parameters from a memory;
loading an image, the image comprising at least one of sub-image pair, each pair comprising a sub-image intended to the left eye and a sub-image intended to the right eye;
applying the first set of parameters to the at least one sub-image of each pair intended to the left eye and the second set of parameters to the at least one sub-image of each pair intended for right eye, and
causing the displaying of the image on a stereoscopic display.

9. The method of claim 8, further comprising: receiving commands from user interface to create and/or modify the first and second set of image pre-compensation parameters.

10. The method of claim 8, further comprising: receiving the first and second set of image pre-compensation parameters using a transceiver.

11. The method of claim 8, further comprising: transmitting the first and second set of image pre-compensation parameters using a transceiver.

12. The method of claim 8, wherein the sub-image intended to the left eye and the sub-image intended to the right eye are identical.

13. The method of claim 8, further comprising: loading the image from a memory.

14. The method of claim 8, further comprising: controlling a transceiver to receive the image.

15. A computer program embodied on a distribution medium, comprising program instructions which, when loaded into an electronic apparatus, control the apparatus to:
read first and second set of image pre-compensation parameters from a memory;
load an image, the image comprising at least one of sub-image pair, each pair comprising a sub-image intended to the left eye and a sub-image intended to the right eye;
apply the first set of parameters to the at least one sub-image of each pair intended to the left eye and the second set of parameters to the at least one sub-image of each pair intended for right eye, and
cause the displaying of the image on a stereoscopic display.
